(19) United States
(12) Patent Application Publication
(10) Pub. No.: US 2005/0198066 A1
(43) Pub. Date: Sep. 8, 2005

(54) Method and system for generating and organizing information in a meeting

(76) Inventor: Allen W. Meyer, Washington, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/791,961

(22) Filed: Mar. 3, 2004

(51) Int. Cl. G06F 7/00

(52) U.S. Cl. 707/104.1

(57) ABSTRACT

The invention includes embodiments of methods and systems for conducting and automating meetings. A method embodiment may include capturing discrete portions of information and generating a note from each of the discrete portions of information. Each note may include visually perceptible note information and computer readable symbology of the note information. The method may further include optionally printing the notes. The method may further include moving the notes to a selected repository and organizing the notes in the selected repository to obtain organized notes. The method may further include optionally scanning each of the computer readable symbologies on each of the organized notes to obtain note information and placing the note information into one or more selected computer software applications. System embodiments and computer media embodiments consistent with the methods are also disclosed herein.

### BACKGROUND OF THE INVENTION

1. Field of the Invention

This invention relates generally to processes for conducting meetings, and specifically relates to a method and system for generating and organizing information in a meeting.

2. Description of Related Art

Meetings can be as simple as two people getting together to have a conversation. More elaborate meetings may include multiple participants with a facilitator, agenda, note taking and generation of meeting minutes to follow-up on action items. Some meetings may be conducted with multimedia technology to display information. Other meetings may be conducted with participants at remote locations. The subject matter for meetings can be essentially limitless.

The information exchanged between participants may be easily managed if there are few participants. However, as the number of participants in a meeting increases, it may become difficult to manage, track and manipulate the data or information generated during the meeting, especially during brainstorming sessions.

Thus, there exists a need in the art for a method and system for generating and organizing information in a meeting.

### BRIEF SUMMARY OF THE INVENTION

An embodiment of a method for generating and organizing information in a meeting is disclosed. The method may include capturing discrete portions of information and generating a note from each of the discrete portions of information. Each note may include visually perceptible note information and computer readable symbology of the note information. The method may further include optionally printing the notes. The method may further include moving the notes to a selected repository and organizing the notes in the selected repository to obtain organized notes. The method may further include optionally scanning each of the computer readable symbologies on each of the organized notes to obtain note information and placing the note information into one or more selected computer software applications.

An embodiment of a system for generating and organizing information in a meeting is disclosed. The system may include an input device and a processor in communication with the input device and configured to execute a computer program. The system may further be configured for receiving discrete portions of information using the input device and formatting each of the discrete portions of information as an output, wherein each output includes a visually perceptible version of each discrete portion of the information and a computer readable symbology of each discrete portion of the information.

Another embodiment of a system for generating and organizing information in a meeting is disclosed. The embodiment includes a computer network, a printer or printers in communication with the computer network and a plurality of computers or other input devices, e.g., a personal digital assistant or tablet computer, in communication with each other and the plurality of printers on the computer network. Each of the plurality of computers may be configured for receiving information and generating an output comprising the information and a computer readable symbology of the information according to the embodiment. The output may be configured for printing notes on media using the printer according to the embodiment of the system. At least one scanner may be in communication with at least one of the plurality of computers for reading the computer readable symbology so that the at least one of the plurality of computers can manipulate the information to obtain note information according to the embodiment of the system.

Computer media for storing a computer program implementing embodiments of a method of the present invention are also disclosed. Additional features and advantages of the invention will be apparent from the detailed description which follows, taken in conjunction with the accompanying drawings, which together illustrate, by way of example, features of embodiments of the present invention.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIG. 1 is a flow chart of an embodiment of a method for generating and organizing information in a meeting according to the present invention.

FIG. 2 is an embodiment of an exemplary note according to the present invention.

FIG. 3 is a block diagram of an embodiment of a system for generating and organizing information in a meeting according to the present invention.

FIG. 4 is a block diagram of another embodiment of a system for generating and organizing information in a meeting in accordance with the present invention.

FIG. 5 is a block diagram of a computer media for storing a computer program, the computer program implementing method for generating and organizing information in a meeting according to an embodiment of the present invention.

FIG. 6 is a computer screen shot of a user interface associated with an embodiment of a computer program consistent with the present invention.

### DETAILED DESCRIPTION OF THE INVENTION

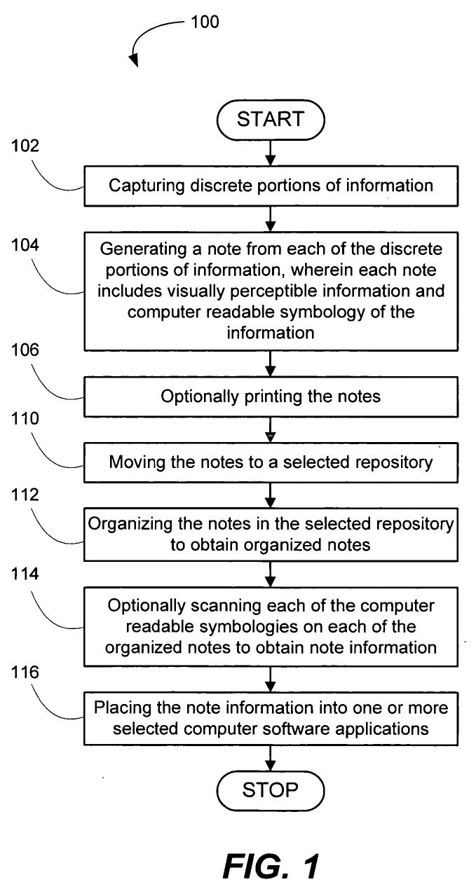

FIG. 1 is a flow chart of an embodiment of a method 100 for generating and organizing information in a meeting according to the present invention. Method 100 may include capturing 102 discrete portions of information. According to an embodiment of method 100, capturing 102 discrete portions of information may include a user typing the information into a keyboard attached to a computer. According to another embodiment of method 100, capturing 102 discrete portions of information may include a user operating a touch pad associated with a computer, or handheld input device such as a personal digital assistant, with a simulated keyboard or having handwriting recognition software capable of digitizing the discrete portions of information. The location of the input device and computer for performing the capturing 102 may be virtually anywhere including remote locations that are capable of communicating by computer networks. The computer network may be any suitable computer network, for example and not by way of limitation, a local area network, a wireless network or a public Internet, according to other embodiments of the present invention.

Method 100 may further include generating 104 a note from each of the discrete portions of information, wherein each note includes human readable information and computer readable symbology of the information. The discrete portions of information for each note may include any kind of information that is gathered, disseminated or shared at a meeting, a brain-storming session, a consultation or any other meeting where information is exchanged in accordance with the embodiments of the present invention. For example and not by way of limitation, where the notes relate to a project that includes various tasks, the discrete portions of information may include at least one of a note category, a textual description, a duration, an owner identification, dependency and a user-defined field according to embodiments of the present invention.

According to another embodiment of method 100, the note may be generated using any suitable computer software capable of receiving the discrete portions of information and formatting the note to include human readable information (for example, alphanumeric text, or text from any suitable language) and also formatting the note to include computer readable symbology which may duplicate the human readable information. According to yet another embodiment of the present invention, the computer readable symbology may be a bar code configured for reading with a bar code reader. According to a specific embodiment, the bar code may be a two-dimensional bar code having higher data density than a conventional vertical line bar code. However, the invention is not limited to embodiments having vertical line bar codes or two dimensional bar codes or combinations thereof. Any sort of computer readable symbology and foreseeable equivalents would fall within the scope of the present invention.

Method 100 may further include optionally printing 106 the notes. The notes may be printed using any kind of printer. The printer may be connected to a network or it may be connected to a particular computer according to embodiments of the present invention. Optionally printing 106 the notes may include printing to any sort or size of print stock media, for example and not by way of limitation, labels, sticky notes (e.g., Post-It™ notes), paper of any size or finish, card stock, transparencies, view graphs, or any other suitable media for printing from a computer. A presently preferred embodiment includes printing to a label, having a self-adhesive surface, suitable for placement on a vertical surface such as a wall or flip chart.

Method 100 may further include moving 110 the notes to a selected repository. For the embodiment where method 100 includes optionally printing 106 the notes, moving 110 the notes to a selected repository may include moving the printed notes to a vertical surface such as a wall or flip chart for further manipulation. For example, moving 110 the notes to the selected repository may include placing the optionally printed notes on a laminated or regular paper flip chart. According to another embodiment, moving 110 the notes to a selected repository may include moving the notes electronically to a computer for electronic manipulation, perhaps in conjunction with a computer screen or window and facilities for manipulating the notes electronically in the computer. According to yet another embodiment moving the notes to the selected repository may include storing the notes on a computer in communication with a projector and displaying a computer image of the notes on a screen.

Method 100 may further include organizing 112 the notes in the selected repository to obtain organized notes. In an embodiment of the present invention, the selected repository may include a flip chart. Notes placed on a flip chart may then be organized by placing and moving the notes as desired. According to another embodiment of the present invention the selected repository may include a memory or buffer in a computer that allows the notes stored within the memory or buffer to be organized using software. According to yet another embodiment, the selected repository may be viewable on a computer screen and, thus, allow organization of the notes by manipulating the note locations on the computer screen. Organizing 112 the notes may include placing the notes in a desired order to obtain ordered notes and adding dependencies and sequential numbers to each of the ordered notes to obtain organized notes according to other embodiments of method 100.

Where method 100 includes the optional printing of the notes, method 100 may further include optionally scanning 114 each of the computer readable symbologies on each of the organized notes to obtain note information. Of course where the discrete portions of information have already been placed in computer readable form as note information, such as by capturing 102, the optional scanning 114 may not be necessary.

Method 100 may further include placing 116 the note information into one or more selected computer software applications. Placing the note information into the one or more selected computer software applications may include importing or exporting the note information into any Mac™, Linux or Windows™ compatible software application, for example and not by way of limitation, Microsoft® Excel™, Word™ and Project™ software applications. Placing the note information into the one or more selected computer software applications may include cutting and pasting from one computer software application to another.

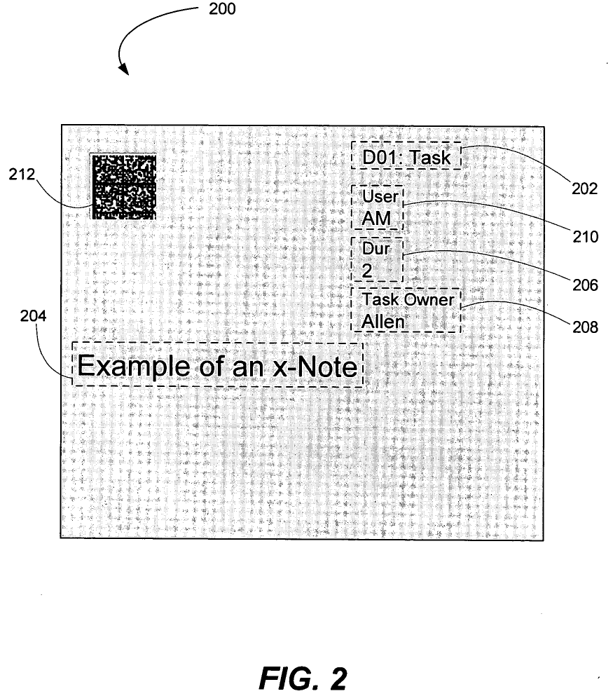

FIG. 2 is an exemplary note 200 according to an embodiment of the present invention. Note 200 may include various fields, such as for example and not by way of limitation, a note category 202, a textual description 204, a duration 206, an owner identification 208, a user field 210, a dependency (not shown in FIG. 2), a user-defined field (also not shown in FIG. 2) and a bar code 212. Any number of fields may be placed on notes according to embodiments of the present invention. Bar code 212 may be any sort of computer readable code. For example, bar code 212 may be a two-dimensional bar code as shown in FIG. 2.

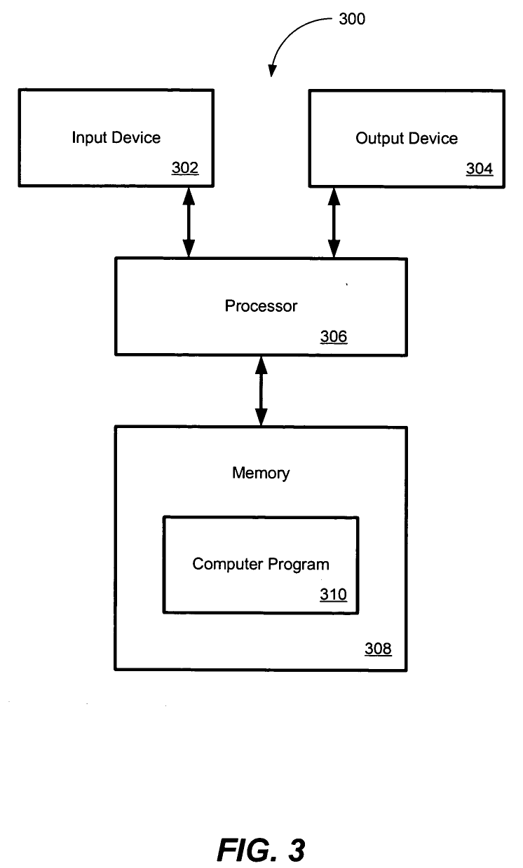

FIG. 3 is a block diagram of an embodiment of a system 300 for generating and organizing information in a meeting according to the present invention. System 300 may include an input device 302 and a processor 306 in communication with the input device 302 and configured to execute a computer program 310. Computer program 310 may implement method 100 as described above. The computer program 310 may be stored in a memory 308 in communication with the processor as shown in FIG. 3. The memory 308 may be any suitable computer memory consistent with embodiments of the present invention. For example, memory 308 may include bulk storage memory, e.g., hard disk drive, or solid state memory, e.g., dynamic random access memory. System 300 may further be configured for receiving discrete portions of information using the input device 302 and formatting each of the discrete portions of information as an output. Each output may include a visually perceptible version of each discrete portion of the information and a computer readable symbology of each discrete portion of the information according to an embodiment of the present invention.

System 300 may further include an output device 304 in communication with the processor 306 configured for communicating the output according to another embodiment of the present invention. Output device 304 may be a printer configured for printing the output. The type of printer is not critical to the invention and may be portable, desktop, laser printer, ink jet printer or any other suitable printer for printing on media. Alternatively, output device 304 may be a computer screen for viewing the output. The output may include a note on label media according to another embodiment of the present invention. System 300 may further include at least one flip chart (not shown for clarity) for receiving and displaying the label media. The flip chart may be of the free standing variety and may include a laminated surface suitable for receiving notes and for hand drawing dependencies. Of course other suitable alternatives to a flip chart, e.g., butcher paper or other surface materials are contemplated to be equivalent substitutes consistent with the present invention, for example and not by way of limitation, a wall or other vertical surface.

The computer readable symbology may include barcoding of any suitable kind, for example and not by way of limitation, two-dimensional barcoding (see barcoding 212 FIG. 2 for example). According to embodiments of system 300, the computer may be at least one of a desktop personal computer, a laptop computer, a tablet computer, a personal digital assistant, instant messenger wireless input device and a remote computer communicating over a computer network. In another embodiment of system 300, the computer may be a computer network. In yet another embodiment of the invention, input device 302 may include a barcode scanner configured to read the barcode, wherein the processor is further configured to import the information in the barcode into at least one computer software application.

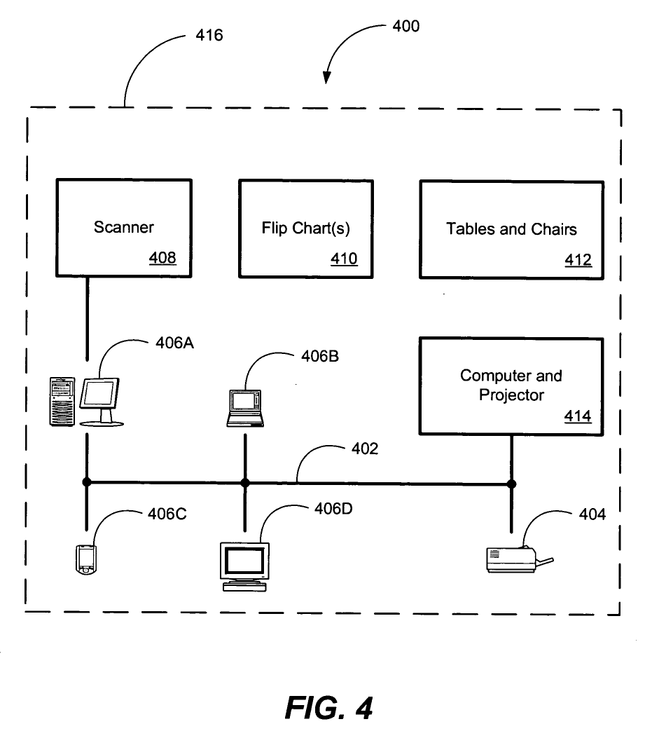

FIG. 4 is a block diagram of another embodiment of a system 400 for generating and organizing information in a meeting in accordance with the present invention. System 400 may include a computer network 402, a printer 404 in communication with the computer network and a plurality of computers 406A-D in communication with each other and the printer on the computer network 402. Each of the plurality of computers 406A-D may be configured for receiving information and generating an output comprising the information and a computer readable symbology of the information, wherein the output is configured for printing notes on media using the printer 404. The media may be label stock. The output may be a note as described above. System 400 may further include at least one scanner 408 in communication with at least one of the plurality of computers (406A in FIG. 4) for reading the computer readable symbology so that the at least one of the plurality of computers (406A in FIG. 4) can manipulate the information to obtain note information.

According to various embodiments of the present invention, there may be any number of computers 406A-D and printers 404. For example and not by way of limitation, FIG. 4 illustrates a desktop computer 406A, a laptop computer 406B, a personal digital assistant 406C and a remote computer 406D that may be linked to the computer network 402 by a public Internet. However, other input devices, such as an instant messenger input device may also be used in an embodiment consistent with the present invention. While only one networked printer 404 is shown in FIG. 4, other printers either networked or local to a computer 406A-D are also contemplated in embodiments of the present invention. The type of printer is not critical to the invention.

System 400 may further include at least one flip chart 210 for displaying printed notes for user to see and manipulate. The flip chart may be simply a wall for placing the printed notes using tape or self-adhesive printed notes. A presently preferred embodiment of a flip chart 210 is laminated and allows for erasable dry ink marking of dependencies between the printed notes placed thereon. Another embodiment of system 400 may further include tables and chairs 412 for use by meeting participants. Yet another embodiment of system 400 may include a projector in communication with at least one of the plurality of computers 414 for displaying at least one of the scanned notes as a computer generated image. Such an embodiment of the present invention allows the manipulation of the notes in software and viewing in real-time using a specialized computer program. The implementation of such a specialized computer program is within the knowledge of one of ordinary skill in the art having possession of this disclosure and, thus, will not be further elaborated on herein. System 400 may be enclosed in a meeting room 416 according to another embodiment of the present invention, although a single meeting room is not required. In fact multiple participants from multiple physically distinct locations may participate in a meeting conducted with embodiments of system 400 using multiple remote computers 406D or other input devices.

According to other embodiments of the present invention systems 300 and 400 need not have the computer program 310 installed on the user's machine. The user may be using a dumb input terminal to talk to a networked computer having the computer program 310 installed as a server. Thus, any remote computer on any network may be suitable as an input device 302 consistent with embodiments of the present invention.

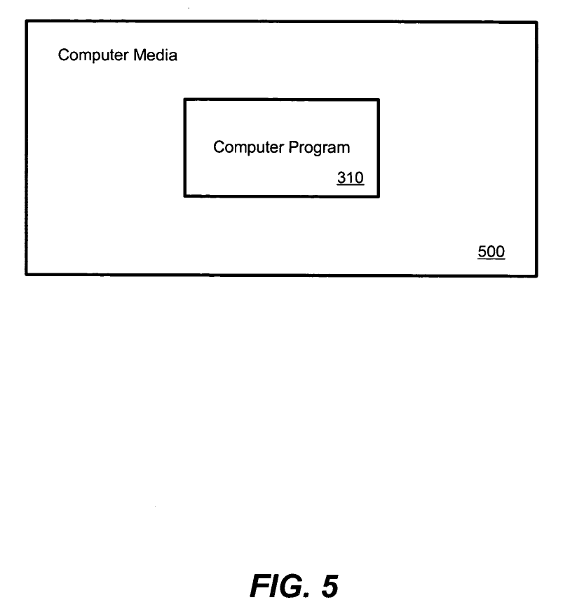

FIG. 5 illustrates a block diagram of a computer media 500 for storing a computer program 310, the computer program 310 implementing method 100 for generating and organizing information in a meeting according to an embodiment of the present invention. Method 100 and its various embodiments as implemented by computer program 502 and stored on computer media 500 may be as described above with reference to FIG. 1. Computer media 500 may be physically formed of solid state, magnetic, optical or magneto-optic media or any other suitable media for the storage of computer programmed instructions.

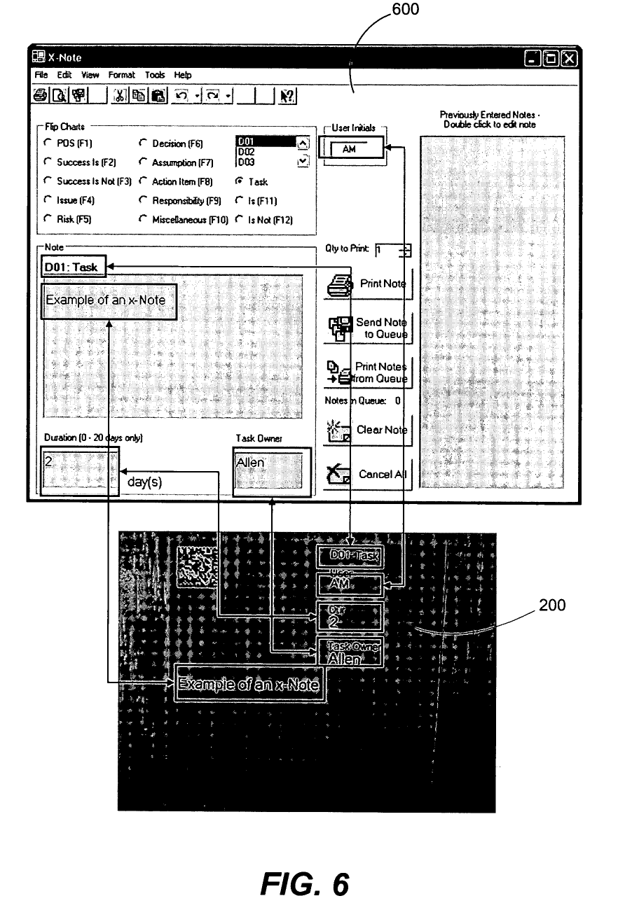

FIG. 6 is a computer screen shot of a user interface 600 associated with an embodiment of a computer program 310 implementing a method 100 for generating and organizing information in a meeting consistent with the present invention. FIG. 6 also illustrates an exemplary correspondence between the various fields entered into the user interface 600 and fields that may be printed on an exemplary note 200. The implementation of such a user interface 600 is within the knowledge of one of ordinary skill in the art having possession of this disclosure and, thus, will not be further elaborated on herein.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

1. A method for generating and organizing information in a meeting, comprising:
capturing discrete portions of information;
generating a note from each of the discrete portions of information, wherein each note includes visually perceptible note information and computer readable symbology of the note information;
optionally printing the notes;
moving the notes to a selected repository;
organizing the notes in the selected repository to obtain organized notes;
optionally scanning each of the computer readable symbologies on each of the organized notes to obtain note information; and
placing the note information into one or more selected computer software applications.

2. The method according to claim 1, wherein capturing the discrete portions of information comprises at least one user entering the discrete portions of information into a computer using a keyboard in communication with the computer or using handwriting recognition technology incorporated into a touch screen in communication with the computer.

3. The method according to claim 1, wherein capturing the discrete portions of information comprises a remote user entering the discrete portions of information into a computer connected to a network.

4. The method according to claim 1, wherein the network is a public Internet.

5. The method according to claim 1, wherein optionally printing the notes comprises printing labels configured for sticking on the selected repository.

6. The method according to claim 1, wherein optionally printing the notes comprises printing on any size paper.

7. The method according to claim 1, wherein the discrete portions of information for each note comprise at least one of a note category, a textual description, a user field, a duration, an owner identification, dependency and a user-defined field.

8. The method according to claim 1, wherein moving the notes to the selected repository comprises placing optionally printed notes on a laminated flip chart.

9. The method according to claim 1, wherein moving the notes to the selected repository comprises storing the notes on a computer in communication with a projector and displaying a computer image of the notes on a screen.

10. The method according to claim 1, wherein organizing the notes comprises:
placing the notes in a desired order to obtain ordered notes; and
adding dependencies and sequential numbers to each of the ordered notes to obtain organized notes.

11. The method according to claim 1, wherein placing the note information into the one or more selected computer software applications comprises importing or exporting the note information into at least one of Microsoft® Excel™, Word™ and Project™.

12. The method according to claim 1, wherein placing the note information into the one or more selected computer software applications comprises importing or exporting the note information into a Windows compatible software application™.

13. A system for generating and organizing information in a meeting, comprising:
an input device; and
a processor in communication with the input device and configured to execute a computer program; and
wherein the system is configured for receiving discrete portions of information using the input device and formatting each of the discrete portions of information as an output, wherein each output includes a visually perceptible version of each discrete portion of the information and a computer readable symbology of each discrete portion of the information.

14. The system of claim 13, wherein the input device comprises a wireless instant messenger input device configured to communicate with the processor.

15. The system of claim 13, further comprising an output device in communication with the processor configured for communicating the output.

16. The system of claim 15, wherein the output device comprises a printer configured for printing the output.

17. The system of claim 16, wherein the output comprises a note on label media.

18. The system of claim 17, further comprising at least one flip chart for receiving and displaying the label media.

19. The system of claim 13, wherein the computer readable symbology comprises barcoding.

20. The system of claim 19, wherein the barcoding comprises two-dimensional barcoding.

21. The system of claim 13, wherein the system comprises at least one of a desktop personal computer, a laptop computer, a tablet computer, a personal digital assistant and a remote computer communicating over a computer network.

22. The system of claim 13, wherein the computer comprises a computer network.

23. The system of claim 13, wherein the visually perceptible version of each discrete portion of the information comprises alphanumeric text.

24. The system of claim 13, wherein the input device includes a barcode scanner configured to read the barcode, wherein the processor is further configured to import the information in the barcode into at least one computer software application.

25. A system for generating and organizing information in a meeting, comprising:
a computer network;
a printer in communication with the computer network;
a plurality of computers in communication with each other and the plurality of printers on the computer network, wherein each of the plurality of computers is configured for receiving information and generating an output comprising the information and a computer readable symbology of the information, wherein the output is configured for printing notes on media using the printer; and
at least one scanner in communication with at least one of the plurality of computers for reading the computer readable symbology so that the at least one of the plurality of computers can manipulate the information to obtain note information.

26. The system according to claim 25, wherein the media comprises label stock.

27. The system according to claim 25, further comprising at least one flip chart for displaying printed notes.

28. The system according to claim 25, further comprising a projector in communication with at least one of the plurality of computers for displaying at least one of the scanned notes as a computer generated image.

29. A computer media for storing a computer program, the computer program implementing a method for generating and organizing information in a meeting, the computer program configured to run on a computer, the method comprising:
capturing discrete portions of information entered by a keyboard in communication with the computer or touch screen on the computer with handwriting recognition software;
generating a note from each of the discrete portions of information, wherein each note includes visually perceptible version a discrete portion of information and computer readable symbology of a discrete portion of the information;
optionally printing the notes on a printer;
moving the notes to a selected repository;
organizing the notes in the selected repository to obtain organized notes;
optionally scanning each of the computer readable symbologies on each of the organized notes to obtain note information; and
placing the note information into one or more selected computer software applications.

30. The computer media according to claim 29, wherein the capturing the discrete portions of information comprises entering the discrete portions of information into a remote computer in communication with the computer by a packet-based network.

31. The computer media according to claim 30, wherein the packet-based network comprises a public Internet.
